(19) United States
(12) Patent Application Publication
(10) Pub. No.: US 2009/0158298 A1
(43) Pub. Date: Jun. 18, 2009

(54) DATABASE SYSTEM AND EVENTING INFRASTRUCTURE

(76) Inventors: Abhishek Saxena, San Jose, CA (US); Neerja Bhatt, Mountain View, CA (US); James W. Stamos, Saratoga, CA (US)

Correspondence Address: HICKMAN PALERMO TRUONG & BECKER/ORACLE, 2055 GATEWAY PLACE, SUITE 550, SAN JOSE, CA, 95110-1083, US

(21) Appl. No.: 11/954,739

(22) Filed: Dec. 12, 2007

(51) Int. Cl. G06F 9/44

(52) U.S. Cl. 719/318

(57) ABSTRACT

A system for managing event monitors within a database is provided. The system can adjust the amount of notifications generated by those event monitors, so as to achieve an effective balance between probability of notification loss and available notification bandwidth, as well as provide a better quality of service to database users.

### FIELD OF THE INVENTION

The present invention relates to event monitors within a database, and adjusting the amount of notifications generated by those event monitors so as to achieve an effective balance between probability of notification loss and available notification bandwidth, and provide a better quality of service to database users.

### BACKGROUND

Within a database system, many available classes of events occur. Examples of different classes of events that occur include modifications to a database object such as a table, a database instance crash, and changes to the state of a message queue. Users, such as administrators, may register to be notified of certain events. Reporting events to such registrants is increasingly becoming a common activity in database systems. To address this, an event monitor, in the form of a background process, can be used to send a notification for each of the various registered events.

However, databases are sometimes arranged in multiple instances, potentially across a wide geographic area. This means that the number of event monitors also increases. In such a case, significant processor resources are required to manage all of the various event monitor communications. Consequently, a means for managing and regulating these event communications is desired.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a block diagram that illustrates an example event processing architecture, according to an embodiment of the invention;

FIG. 2 depicts a system that implements the architecture of FIG. 1 across multiple instances;

FIG. 3 depicts a time-line used within the system of FIG. 2; and

FIG. 4 is a block diagram that illustrates a computer system upon which an embodiment of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

In real application clusters (RAC) topology, database functionality may be spread across multiples nodes or instances. Additionally, both the volume and the variety of events occurring within database systems are continually changing in size and scope.

In an embodiment, a database system and eventing infrastructure comprises a plurality of instances. An instance comprises a set of operating system processes and memory structures that interact with data storage. Multiple instances of database servers can run in parallel on multiple nodes, and yet still be part of the same database. These instances can be distributed across a shared-disk architecture such as RAC, although the invention described herein is not limited thereto.

The database system and eventing infrastructure described herein provides a mechanism to register for events of interest, and send notifications to that registrant when various of those events occur within the database system. To achieve this, a notification server background process known as an event monitor sends notifications for each of various registered events. Each instance has its own event monitor, and that event monitor sends notifications for various events occurring within that instance.

One of the purposes of the database system described herein is to minimize data loss when an instance dies or crashes. Inevitably however, when an instance death occurs there will be some loss of data contained on that instance. However, data on all remaining instances will continue to be sent at the proper times. Also, if an instance shuts down or fails, the database system will automatically relocate various responsibilities within that instance to a surviving instance.

Another purpose of the database system is to decrease loss of data due to death of instances, but at the same time to be aware of the overall efficiency of the system. A tunable parameter achieves this feature.

Another purpose of the database system is to evenly distribute the load of registrations across the various instances.

### Definitions

An “event” may be any occurrence of interest in a database system, whether that occurrence is a change to a file or object managed by the database system, or the amount of consumed shared memory in the database system at a particular point in time. Additionally, an event can also be the lack of activity. For example, an administrator may register to be notified if a table is not accessed within a certain specified period of time.

An application issues a request to register for a single notification that represents a group of events that each satisfies one or more grouping criteria. Such a request is referred to hereinafter as a “grouping registration request”, and the requester is referred to as a “registrant”.

An “event monitor” receives and maintains these grouping registration requests. When an event is received, the event monitor determines whether the event has been registered for an active grouping registration, where “active” means a grouping registration that is not crashed or dead, and is also not yet completed. If active, then the event monitor updates grouping data that are associated with the grouping registration. When completion criteria associated with a grouping registration are satisfied, a notification is sent to the registrant. The notification may provide a summary of all the events in the group or provide details about a single event from the group, such as the latest event.

The events that satisfy one or more grouping criteria of a grouping registration are referred to hereinafter as “grouping registration events”.

Each grouping registration is associated with one or more “completion criteria”, which may or may not be specified in the registration request. The completion criteria indicate when various of the grouping events for a single notification may cease.

In response to the completion criteria of a grouping registration being satisfied, a notification is sent to one or more intended recipients. Such a notification is referred to hereinafter as a “grouping notification.”

A “grouping timeout” occurs when the completion criteria of a particular grouping registration are satisfied, and the timeout may or may not be based on time. A grouping notification is then sent to the registrant that did the grouping registration.

An example of a grouping registration request could be as follows. Suppose a registrant wishes to be notified once every ten minutes if a new message from user U is enqueued in a queue Q during that period. In this example, the “grouping criteria” that an event must satisfy in order to be a grouping registration event are (1) a new message (2) from user U (3) that is enqueued in queue Q.

However, it is important to separate “grouping criteria” from “completion criterion”, as they are not the same. Continuing the example, the completion criterion is the occurrence of at least one such event in a 10-minute period. If at least one such event does not occur in the 10-minute period, then no grouping notification is sent. If one or more such events occur in the 10-minute period, then one grouping notification is sent at the end of the 10-minute period, regardless of whether two or one hundred such events occurred in that period.

### Overview of Eventing Mechanism

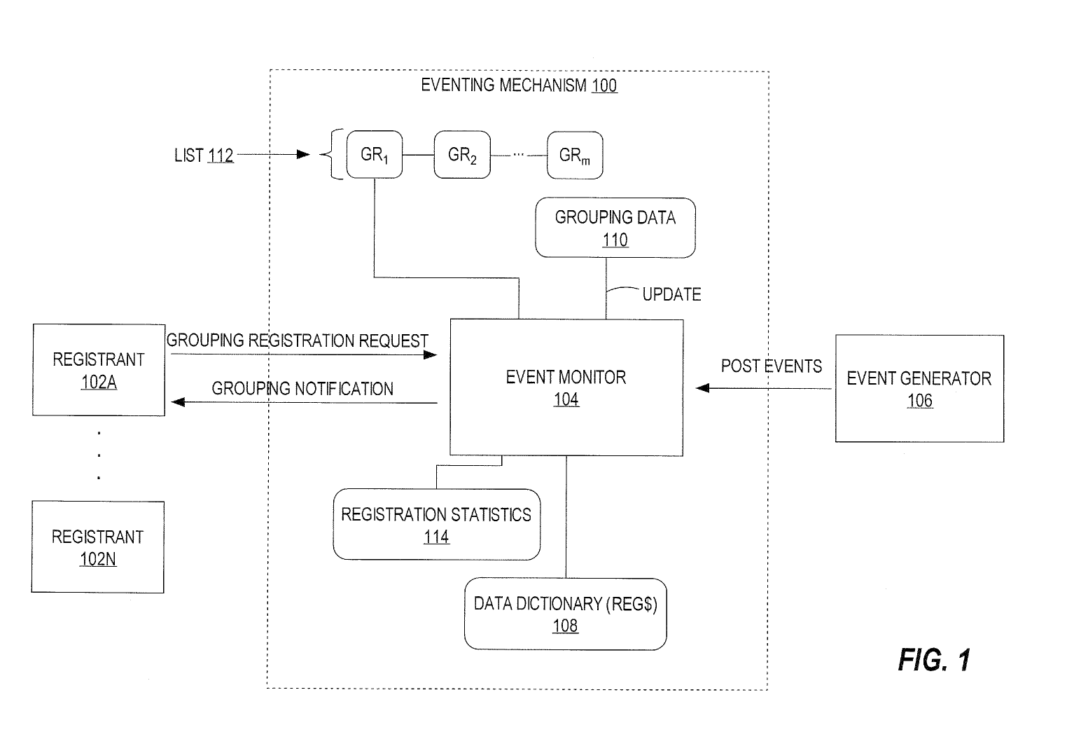

FIG. 1 is a block diagram that illustrates an example eventing mechanism 100, shown with multiple registrants 102A-102N. As used hereinafter, “registrant” refers to the application that issues a grouping registration request. A registrant 102 may issue a grouping registration request from any computing device, such as a mobile phone, PDA, laptop computer, or a desktop computer.

As illustrated in FIG. 1, the eventing mechanism 100 comprises an event monitor 104, which may be implemented as a single process or multiple processes. The event monitor 104 processes group registration requests from the registrants 102_{A-N}. Event monitor 104 may also process non-grouping registration requests, i.e., requests to be notified separately for each event that satisfies criteria specified in the request.

FIG. 1 also illustrates an event generator 106 that generates events and provides (posts) the events to the event monitor 104. The event generator 106 may be any process that tracks events in a computing system. Alternatively, event generator 106 may be any process that makes changes to the computing system. For example, event generator 106 may be a process that enqueues a message and a process that dequeues a message. As another example, event generator 106 may be a process that updates a table or an index in a database. Therefore, in addition to executing a user request or a system request, a particular process also provides the event(s) to the event monitor 104.

Communication links between registrants 102_{A-N}, eventing mechanism 100, and event generator 106 may be implemented by any medium or mechanism that provides for the exchange of data. Examples of communications links include, without limitation, a network such as a Local Area Network (LAN), Wide Area Network (WAN), Ethernet or the Internet, or one or more terrestrial, satellite, or wireless links.

### Grouping Data

As shown in FIG. 1, an example event monitor 104 maintains grouping data 110 for each grouping registration, which may be stored in shared memory. Thus, each grouping registration has its own grouping data 110. Grouping data 110 may be implemented in the form of a list 112, where each entry in the list corresponds to one or more events. Thus when an event occurs, a new entry may be created and added to the appropriate list 112 within the grouping data 110, or an existing entry may be updated.

When the completion criteria of a grouping registration are satisfied, a notification (including a subset of the corresponding grouping data) is sent, and the corresponding grouping data may be deleted.

The level of detail for grouping data 110 of a grouping registration may depend on the registrant's intent. For example, if the registrant only wants details about the last event of a plurality of grouping registration events, then grouping data 110 for that registration might not be maintained at all. As another example, a grouping registration request may indicate that the registrant desires to be notified once every ten minutes if at least two updates to table T were issued during that period. The notification may simply indicate that 3 updates to table T were issued during a particular 10-minute period. Thus, the corresponding grouping data might only indicate as much.

If an event that satisfies the grouping criteria of one or more grouping registrations occurs, then the event monitor 104 updates the grouping data 110 that correspond to the one or more grouping registrations.

### Grouping Attributes

A grouping registration request is processed according to one or more criteria. Each criterion of the one or more criteria is referred to hereinafter as a “grouping attribute.” A grouping attribute informs an eventing mechanism about how to process the corresponding registration request. A grouping registration request typically specifies at least one grouping attribute. Some grouping attributes may be specified in the registration request while other grouping attributes may be assigned default values, which may be configurable by a user/administrator of the database system.

Examples of grouping attributes that may be associated with each grouping registration request may include, but are not limited to: (1) class, (2) value, (3) type, (4) start time, and (5) repeat count.

“Class” refers to one or more criteria for grouping. Examples of values for the class attribute include, without limitation, time, transaction, event, and size. If an event that belongs to a class that is specified in an active grouping registration occurs, then the grouping data associated with that grouping registration is updated. The values of one or more class attributes are the one or more “grouping criteria” referred to above.

“Value” refers to a value for a grouping criterion. For example, if the class attribute value of a grouping registration request is “time,” then a value for the value attribute may be a number of seconds. As another example, if the class attribute value of a grouping registration request is a particular transaction, then a value for the value attribute may be a number of such transactions. The values of one or more value attributes are the one or more “completion criteria” referred to above.

If the grouping registration does not specify a value attribute, then a default value for the value attribute may depend on the value of the class attribute. For example, if the value of the class attribute is “time,” then the default value of the value attribute may be ten minutes. As another example, if the value of the class attribute is “transaction,” then the default value of the value attribute may be twenty transactions.

“Type” refers to the format of a grouping notification that results from the grouping registration. For example, a value of the type attribute may be “summary,” which indicates that the grouping notification will provide a summary of the events that satisfy the grouping criteria. For a group of messages enqueued to a queue, a summary may contain the message identifiers of all the messages in the group. For a group of rows in a table, a summary may contain the row identifiers of all rows updated in the group.

As another example of a value of the type attribute, a value of the type attribute may be “last,” which indicates that the grouping notification will provide details only about the last event that satisfies the grouping criteria. An example of a default value for the type attribute is “summary.”

“Start time” refers to a time to begin grouping events that satisfy the one or more grouping criteria. For example, a value of the start time attribute might be Jul. 1, 2007, 12:00 AM, which indicates that events will not be grouped for the corresponding grouping registration until that date and time. If the grouping registration does not specify a start time, then a default value for the start time attribute may be the current time, indicating that the registrant intended the grouping to begin immediately. Before the start time of a grouping registration, the grouping registration may be treated as a non-grouping registration.

“Repeat count” refers to a number of times to perform grouping according to the one or more grouping criteria. For example, if the grouping registration specifies “6” for the repeat count, then the registrant will receive six grouping notifications for six sets of events that occurred in six different time intervals. If the grouping registration does not specify a repeat count, then a default value for the repeat count attribute may be a value indicating infinity, indicating that the registrant intended to receive grouping notifications indefinitely. After the repeat count of a grouping registration becomes zero, the grouping registration may be treated as a non-grouping registration.

### Timeout Value

A registration request may specify a timeout value. A timeout value is separate from the one or more completion criteria associated with a grouping registration. A “timeout” takes precedence over a grouping repeat count. Thus, if a timeout occurs in the middle of a grouping value period, then the event monitor 104 flushes the grouping data of the corresponding registration and sends an early grouping notification before removing the registration.

Meanwhile, a “grouping timeout” occurs when the completion criteria of a particular grouping registration are satisfied. A grouping notification is then sent to the registrant that did the grouping registration. Thus, a timeout value is different than a grouping timeout.

### Instance Death (Crash)

As stated, the database system in which the eventing mechanism 100 executes may be distributed among a cluster of nodes, such as but not limited to a RAC. Each node comprises a computing element, such as personal computer, workstation or blade server. Each node executes a separate instance of a database server. Each database instance manages and shares access to a database. In such an arrangement, it is not uncommon for one or more database instances to go down, for either planned or unplanned reasons. If a database instance is down or crashed (e.g., unable to process requests for data from the database), then the grouping data maintained by that database instance should be accounted for.

Therefore, according to an embodiment, upon the death or crash of an instance, all grouping data within that instance is flushed, grouping notifications are sent to each registrant 102, and the grouping process is begun anew.

When an instance dies there may be some data loss. When an instance dies, all grouping data on that instance that was not flushed during the periodic refreshing will be lost. However, the rest of the grouping data on all remaining instances for that registration will continue to be sent at the proper times.

### Example Grouping Registration Requests

The following are examples of grouping registration requests. If a grouping attribute is not specified in the example, then a default value is used.

### EXAMPLE 1

A registrant wants to be notified every time M messages arrive in queue Q for subscriber S. In this example, the grouping criteria that an event must satisfy are (1) a message (2) that arrives in queue Q (3) for subscriber S. The completion criterion is the number of such messages—M. The repeat count is indefinite (i.e., “every time”).

### EXAMPLE 2

A registrant wants to be notified every time table T increases in size by K kilobytes since the last grouping notification to the registrant. In this example, the grouping criteria that an event must satisfy are (1) an update (2) to table T. The completion criterion is the number of kilobytes that table T increases—K. The repeat count is indefinite (i.e., “every time”).

### EXAMPLE 3

A registrant wants a colleague to be notified every time, for a hundred times, when S additional subscriptions are received for newspaper N. In this example, the grouping criteria that an event must satisfy are (1) a subscription (2) to newspaper N. The completion criterion is the number of such subscriptions—S. The repeat count is one hundred.

### EXAMPLE 4

A registrant wants to be notified every fifteen minutes if at least one home run is hit during that 15-minute period. With each notification, the registrant wants information only about the last home run that is during that period. In this example, the grouping criterion is a home run. The completion criterion is at least one home run in a 15-minute period. If no home runs are hit in a 15-minute period, then a notification is not sent to the registrant. The value of the type attribute is “last.” The repeat count is indefinite.

### EXAMPLE 5

A registrant wants to be notified when user U has initiated ten bank transactions in a single day. With the notification, the registrant wants a summary of all the transactions. In this example, the grouping criteria that an event must satisfy are (1) a bank transaction (2) initiated by user U. The completion criterion is ten bank transactions in a single day. If user U does not initiate at least 10 transactions in a single day, then a notification is not sent to the registrant. Also, if user U does not initiate at least 10 transactions in a single day, then any accumulated grouping data is not included in a subsequent notification. For example, such accumulated grouping data may be deleted at the end of the day.

### EXAMPLE 6

A registrant wants to be notified every time driver D is ticketed for three traffic violations. In this example, the grouping criteria that an event must satisfy are (1) a traffic violation (2) for driver D. The completion criterion is the number of such traffic violations—three. The repeat count is indefinite (i.e., “every time”).

### Overview of System

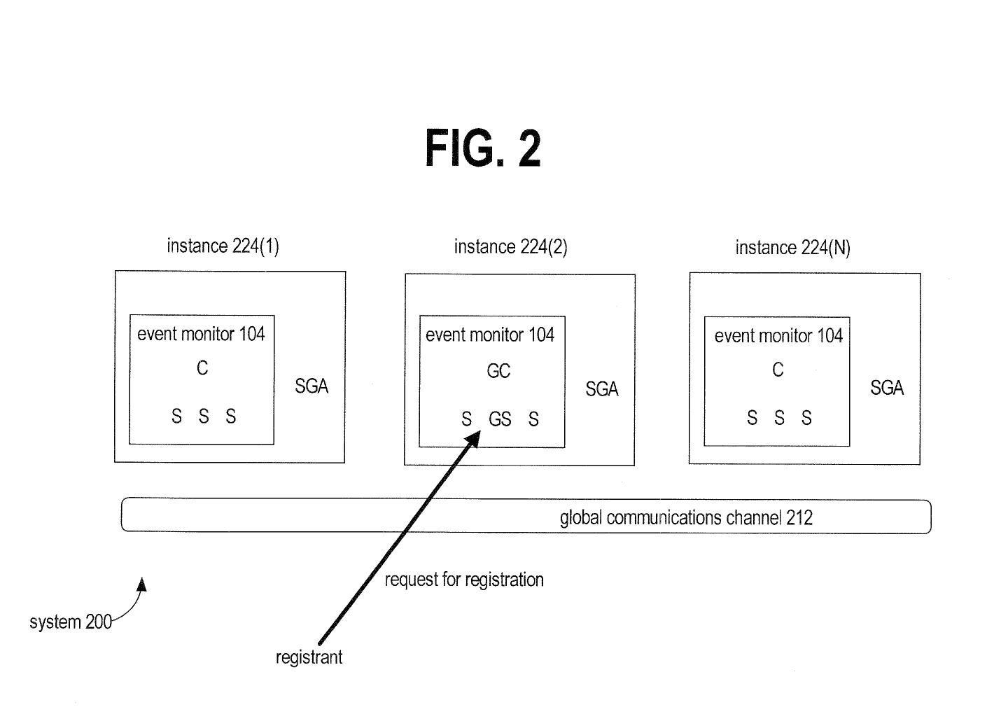

In FIG. 2 a database system and eventing infrastructure 200 gathers grouped events within a relational database management system 200 which as shown has multiple instances 224₁, 224₂, . . . 224_{N}. A grouping registration will be associated with an event monitor slave S on each instance (shown in FIG. 2 as a grouping slave or GS). One of these GSes across all instances will be denoted the grouping coordinator or GC for that specific registration, and will be responsible for sending grouping notifications to the registrants at grouping timeout. Each instance 224 has exactly one event monitor 104 associated therewith, as well as exactly one system global area (SGA) associated therewith.

As shown in FIG. 2, an event monitor comprises a coordinator and several slaves. When a registration request arrives to a specific instance 224, that registration is associated with a specific slave, which is thereafter designated as a grouping slave.

The system 200 also includes a RAC-wide global publish-subscribe communication channel 212. Each event monitor slave S will subscribe to this global channel at startup time and remain permanently subscribed. Within each instance 224, a server-side memory structure known as a system global area (SGA) holds cache information such as data-buffers, SQL commands and client information.

The global communication channel 212 will be used for sending messages containing partially grouped data of events (also called partial group of events) from GSes to a GC for every grouping registration. For a given grouping registration, a partial group is grouped data of events, for that registration, at one of the several RAC server instances, and total group, for a given grouping registration, is the combination of all partial groups of events, for that registration, from all instances. The message will have a message header and a message body. The message header will contain message metadata information such as subscription name, and namespace and message type such as grouping or special event (such as timeout, shutdown or unregister). The message body will contain the partial group or payload of events collected so far at an instance.

Examples of a message body include at least the following. Within a given namespace NS1, the message body could be a collection of message ids of all messages enqueued to a queue so far (each message enqueue being an event). Within a given namespace NS2, the message body could be a collection of rowIDs updated in a table holding all updates so far (where each row update is an event).

Within the system 200, there is exactly one GC per registration. Within the system 200, there could be a large number of instances, although only three instances are shown in FIG. 2. Accordingly, there likely will be thousands of registrations and thus thousands of GCs, but there will be one GC per registration. For simplicity, FIG. 2 shows only three instances, only one registrations among those instances, and thus only one GC for that registration. However, it should be understood that a typical usage of the system 200 will likely have many more instances, thousands of registrations and thus thousands of GCs, and will thus be much more complex than what is shown in FIG. 2. Regardless of the specific amount, it is preferable for the system 200 to distribute the load of registrations evenly across all of the various instances 224_{1-N}.

As shown in FIG. 2, registration requests are handled by the specific instance that is closest to where the registration was originated. FIG. 2 also shows that each instance has exactly one event monitor 104, which all have a coordinator C and a plurality of slaves S. When a registration request arrives at the instance, that request is associated with one of the event monitor slaves S, randomly chosen, and that slave is then promoted to grouping slave (GS). The GS and GC may be chosen randomly, to help maintain an even load distribution within the system 200.

As shown in FIG. 1, the data dictionary 108 (reg$) stores the registration information, including that registration's grouping_inst_ID. This tracks the identity of the GC for a particular registration across all instances. The GS which happens to be located on the grouping_inst_ID instance becomes the GC. In FIG. 2, the grouping_inst_ID associated with the registrant shown therein will be assumed to be 2. The grouping_inst_ID may or may not be the instance where the registrant created the registration.

As events occur and therefore create need for notifications, each GS will build groupings, and at various times forward those groupings to the GC. When a grouping timeout occurs, only the GC will send a notification to the registrant 102. This reduces traffic and noise within the system 200, and also reduces the amount of communications that a registrant 102 must manage.

Each instance looks after events occurring therein, and builds partial groups. If a particular partial group is not empty at a particular grouping timeout, that partial group will send a grouping notification to the registrant associated therewith. Because of potential for a large number of instances, there could be large number of partial grouping notifications to a particular registrant, which has the burden of combining all of these notifications.

To address this, the system 200 combines all of the partial grouping notifications, thereby relieving the registrant from doing so, and also reduces the overall number of notifications to registrant. The various GS′ associated with a specific grouping funnel all their grouping notifications solely to one GC. That single GC then sends all of the grouping notifications to the registrant.

As stated, one of the purposes of the system 200 is to provide failure protection. For example, if an instance death occurs, the system 200 will automatically relocate the GC to a surviving instance. At the death of an instance, all remaining instances have an “I'm still alive” callback. The system 200 will then select a new grouping_inst_ID and a new GC for each registration associated with that instance. A new GC is generally only elected at an instance crash, or at the time of registration.

Grouping can be supported in a time dimension (also called grouping by time), where registered events are grouped at client-specified time intervals. However, as stated earlier, the system 200 can also support grouping by non time-based grouping criteria such as number of events, number of transactions, size of grouping data, or numerous other useful dimensions.

### Grouping_Inst_ID

A grouping_inst_ID will be generated for each specific registration on the registering instance at the time of registration. All grouping_inst_IDs are persisted to disk. The registration will be immediately visible to all instances 224_{1-N} through the global communication channel 212. A GS that happens to be located within the instance grouping_inst_ID will then become the GC for that registration.

Each instance has a GS associated with a specific registration. One of the instances is selected as a grouping_inst_ID. GC will be the GS within the instance called grouping_inst_ID.

### Duties and Responsibilities of a GS

The GS also does a Periodic Grouping Data Publish (PGDP). Each GS will build its partial group in its instance's SGA as events occur on that instance. Periodically, each GS will publish its partial group on the global communications channel 212, but only unicast (non-broadcast) to a specific GC.

In an embodiment, each grouping slave GS immediately forwards grouping notifications to a grouping coordinator GC, which groups forwarded events appropriately. Every time an event is generated, the slave S handling that event must forward that event to the GC. However, a RAC arrangement for example may have thousands or more events occurring per second, and thus a large number of slaves S. Slaves hold metadata associated with a grouping in an instance's system global area (SGA).

The various GS′ will allocate memory for the global message object and copy the grouping data from their SGA to the message object, and publish the message on the channel 212 as a unicast to the GC using the grouping_inst_ID. The GSes will then delete their partial groups from their SGA after sending them to GC. All messages sent on the global communications channel 212 must contain at least a message header and grouping data.

The GS will build a partial group of events within its own memory, and periodically publish the partial group to the GC. To publish means unicast to GC only, and not bother anyone else. Unicasting minimizes communication traffic on the global channel 212.

### Accuracy Window ‘f’

Suppose the global channel 212 allows up to ‘n’ KB size messages, where n is a positive number. The GSes will publish grouping data either when a pre-specified time ‘t’ elapses, or when grouping data becomes large enough for a ‘n’ KB sized message. To clarify this, assume that ‘f’ is a multiplicative factor of the grouping interval and ‘m’ is the minimum periodic refresh time granularity that can be supported within the system 200, where ‘f’ is a fraction, 0<f<1, and ‘m’ is a positive number. The pre-specified time ‘t’ will be such that t=max (f*grouping time interval, m) for grouping by time.

There exist tradeoffs for small and large values of ‘f’. Large values of ‘f’ imply less frequent data publishes by GSes, reduced strain on the resources of the system 200, and increased risk of data loss. Meanwhile, small values of ‘f’ imply more frequent refreshes of grouped events, and thus greater strain on the resources of the system 200, but decreased risk of data loss.

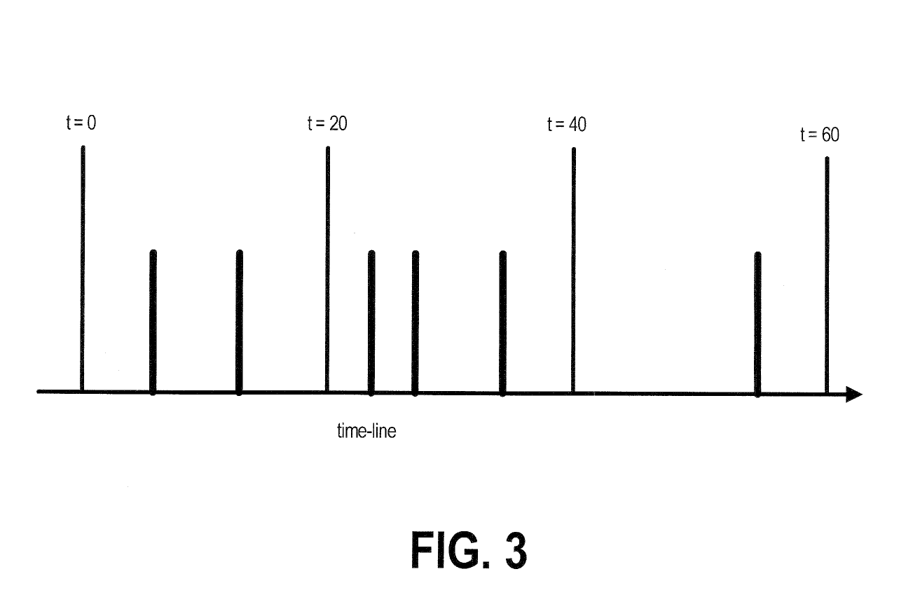

In a time-based system, the GS will publish every ‘t’ seconds. An example of the timings of the system 200 is shown in FIG. 3. The total elapsed time is 60 seconds, with f=⅓, thus GS will send partial grouping data every 20 seconds.

The variable ‘f’ defines the accuracy window, and is always between 0 and 1. The system 200 will arrive at appropriate defaults for ‘f’ and may also retain an option for a user or administrator to tune if it seems like the overall mechanics of the system 200 are running poorly. The value contained in ‘f’ is inversely proportional to the accuracy of grouping data, so that a smaller ‘f’ means more data sent from GS to GC, and a greater ‘f’ means less data sent.

Referring to the example shown in FIG. 3, it is apparent that 2 grouping updates occur in the period t=(0-20), 3 grouping updates occur in the period t=(20-40), and 1 grouping update occurs in the period t=(40-60).

In the event of the death of an instance, the system 200 strives to reduce if not eliminate the amount of lost data, yet balance this with not overburdening the system 200 with sending needless messages. A goal of the system 200 is partly to decrease loss of data due to death of instances, but also to consider the overall efficiency of the system 200. The tunable ‘f’ parameter achieves this feature as follows. Using the example in FIG. 3, if the instance dies at t=25, but that instance sent its partial group at t=20, then only the grouping data accumulated between t=20 and t=25 is lost. However, supposing ‘f’ was set to ½ rather than ⅓, then all grouping data between t=0 and t=25 would be lost.

For non time-based grouping, a reasonable default value for the periodic publish event would be applied. A database initialization parameter such as a multiplicative factor of grouping criterion can also be used to assist in achieving this purpose. This parameter may be hidden, but may also be available to a user.

The GC will periodically check the global channel 212 for any periodic cross-instance grouping data updates, based on the pre-specified time interval as described above. If any updates exist, the GC will read the message from the global channel 212 and update the grouping data held in its SGA. This is known as a Periodic Grouping Data Consume (PGDC), and is performed by the GC.

In the event that a GC's instance dies, instance death callbacks will be invoked on all live instances and a new grouping_inst_ID will be chosen from available instances, persisted to disk, and a registration will be assigned this new GC. The change will be visible on all live instances when the database is shared, and will be visible on all live instances through the global channel 212 when the database is not shared. Grouping will start afresh from whatever grouping data was available in the SGA of instances alive at that time (when a GC's instance dies). In the event of a grouping timeout (a natural completion, not a crash), the GC will send the grouping notification as a single notification to the registrant.

### Alternate Embodiments

As stated, the system 200 is not limited to shared disk arrangements of databases, such as RAC. The system 200 can also accommodate distributed databases that employ disk replication. Further, the system 200 can accommodate non-sharing instances, or arrangements which segregate a single database across numerous instances. In other words, the system 200 can work among divided databases such as where all A's go here, B's go here, and C's go here, which means three different databases that are independent and don't share disks. The system 200 could apply the same logic used to detect when an instance goes down, and apply that logic to detect when a database goes down.

The system 200 has less bursty, more steady inter-instance communication with less overhead and more effective bandwidth utilization. Also, in general, inter_instance global communication is reduced. The system 200 also minimizes loss of grouping data, due to the steady reliable periodic refreshes of grouping data as exemplified in FIG. 3.

The system 200 is also scalable and extendable, and will work well for non time-based grouping of events as well as other types that are not yet known but can be supported in the future.

The system 200 provides an even load distribution across all database servers, whether RAC or otherwise. Since the various GS's and GC's will be selected randomly across all instances, the system 200 ensures a reasonable load distribution of all grouping registration and notifications across all slaves S within the entire database.

The system 200 thus reduces the load on the database servers. The server processes will use less system resources and network bandwidth and handle lesser number of connections to the registrants, because the volume of communications thereto will be reduced. That is, the volume of events themselves will not be reduced, but the communications regarding those events will be reduced.

Within the system 200, the registrants are freed from assembling the notifications of partial groups of events from multiple server processes. The registrants also handle fewer connections from server processes since only the GC's send the grouping notifications. Accordingly, the system 200 reduces work load for registrants. The system 200 thus provides a robust infrastructure for gathering and notifying grouped events within a database, including but not limited to databases structured using RAC topology.

### Hardware Overview

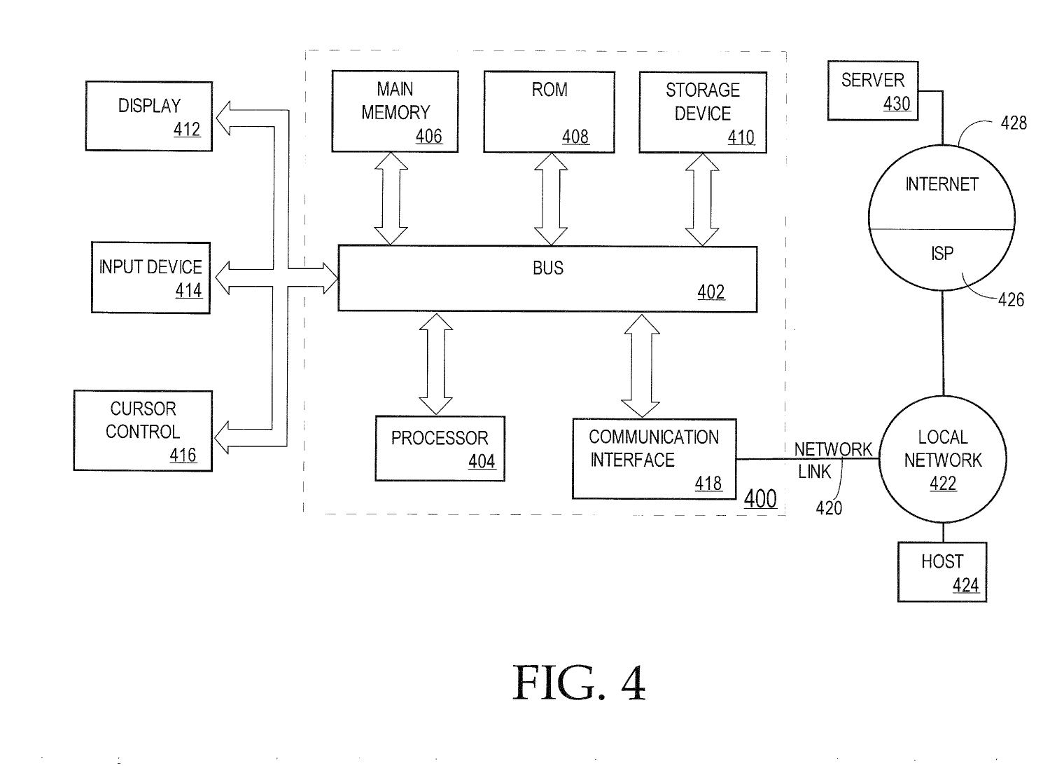

FIG. 4 is a block diagram that illustrates a computer system 400 upon which an embodiment of the invention may be implemented. Computer system 400 includes a bus 402 or other communication mechanism for communicating information, and a processor 404 coupled with bus 402 for processing information. Computer system 400 also includes a main memory 406, such as a random access memory (RAM) or other dynamic storage device, coupled to bus 402 for storing information and instructions to be executed by processor 404. Main memory 406 also may be used for storing temporary variables or other intermediate information during execution of instructions to be executed by processor 404. Computer system 400 further includes a read only memory (ROM) 408 or other static storage device coupled to bus 402 for storing static information and instructions for processor 404. A storage device 410, such as a magnetic disk or optical disk, is provided and coupled to bus 402 for storing information and instructions.

Computer system 400 may be coupled via bus 402 to a display 412, such as a cathode ray tube (CRT), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

The invention is related to the use of computer system 400 for implementing the techniques described herein. According to one embodiment of the invention, those techniques are performed by computer system 400 in response to processor 404 executing one or more sequences of one or more instructions contained in main memory 406. Such instructions may be read into main memory 406 from another machine-readable medium, such as storage device 410. Execution of the sequences of instructions contained in main memory 406 causes processor 404 to perform the process steps described herein. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing data that causes a machine to operation in a specific fashion. In an embodiment implemented using computer system 400, various computer-readable media are involved, for example, in providing instructions to processor 404 for execution. Such a medium may take many forms, including but not limited to storage media and transmission media. Storage media includes both non-volatile media and volatile media. Non-volatile media includes, for example, optical or magnetic disks, such as storage device 410. Volatile media includes dynamic memory, such as main memory 406. Transmission media includes coaxial cables, copper wire and fiber optics, including the wires that comprise bus 402. Transmission media can also take the form of acoustic or light waves, such as those generated during radio-wave and infra-red data communications. All such media must be tangible to enable the instructions carried by the media to be detected by a physical mechanism that reads the instructions into a computer.

Common forms of computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of computer-readable media may be involved in carrying one or more sequences of one or more instructions to processor 404 for execution. For example, the instructions may initially be carried on a magnetic disk of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the world wide packet data communication network now commonly referred to as the “Internet” 428. Local network 422 and Internet 428 both use electrical, electromagnetic or optical signals that carry digital data streams. The signals through the various networks and the signals on network link 420 and through communication interface 418, which carry the digital data to and from computer system 400, are exemplary forms of carrier waves transporting the information.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418. The received code may be executed by processor 404 as it is received, and/or stored in storage device 410, or other non-volatile storage for later execution.

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A computer-implemented method for communicating notifications between a plurality of instances executing on a multi_instance system, comprising:
a registrant registering to receive notifications related to a plurality of specific events, where said notifications are generated by a plurality of processes executing on said multi-instance system;
wherein said plurality of processes communicate with each other via a global channel;
in response to receiving said registration, assigning a coordinator process among said plurality of processes to send said notifications to said registrant; and
said coordinator process sending said notifications to said registrant.

2. The method of claim 1, further comprising:
said plurality of processes further comprises a plurality of slave processes; and
said slave processes sending grouping notifications to said coordinator process.

3. The method of claim 2, further comprising:
said slave processes being located on a different instance than said coordinator process.

4. The method of claim 2, further comprising:
each slave process of the plurality of slave processes updating data associated with a specific registration; and
designating a single slave process as a coordinator process.

5. The method of claim 1, further comprising:
publishing data related to progress of said notifications as specified by a user.

6. The method of claim 1, further comprising
publishing data related to progress of said notifications when a pre-specified time ‘t’ elapses, where ‘f’ is a fraction, 0<f<1, which is a multiplicative factor of the grouping time interval, and where ‘m’ is the minimum supportable periodic refresh time of the system, so that the pre-specified time ‘t’ is t=max (f*grouping time interval, m).

7. The method of claim 2, further comprising:
if one of said plurality of instances fails, designating a new coordinator process from a slave processing within one of the remaining non-failed instances.

8. The method of claim 1, further comprising:
load-balancing a plurality of said registrations to be located evenly among all of said instances.

9. A computer-implemented method for communicating notifications between a plurality of instances executing on a multi-instance system, comprising:
a plurality of processes executing on said multi_instance system generating notifications;
in response to receiving a registration from a registrant, assigning a coordinator process among said plurality of processes to send said notifications to said registrant; and
said coordinator process sending said notifications to said registrant.

10. The method of claim 9, further comprising:
said plurality of processes further comprises a plurality of slave processes; and
said slave processes sending grouping notifications to said coordinator process.

11. The method of claim 10, further comprising:
each slave process of the plurality of slave processes updating data associated with a specific registration; and
designating a single slave process as a coordinator process.

12. The method of claim 9, further comprising:
wherein said plurality of processes communicate with each other via a global channel.

13. The method of claim 9, further comprising:
publishing data related to progress of said notifications as specified by a user.

14. The method of claim 9, further comprising
publishing data related to progress of said notifications when a pre-specified time ‘t’ elapses, where ‘f’ is a fraction, 0<f<1, which is a multiplicative factor of the grouping time interval, and where ‘m’ is the minimum supportable periodic refresh time of the system, so that the pre-specified time ‘t’ is t=max (f*grouping time interval, m).

15. A computer-readable storage medium storing one or more sequences of instructions which, when executed by one or more processors, causes the one or more processors to perform the method recited in claim 1.

16. A computer-readable storage medium storing one or more sequences of instructions which, when executed by one or more processors, causes the one or more processors to perform the method recited in claim 2.

17. A computer-readable storage medium storing one or more sequences of instructions which, when executed by one or more processors, causes the one or more processors to perform the method recited in claim 3.

18. A computer-readable storage medium storing one or more sequences of instructions which, when executed by one or more processors, causes the one or more processors to perform the method recited in claim 4.

19. A computer-readable storage medium storing one or more sequences of instructions which, when executed by one or more processors, causes the one or more processors to perform the method recited in claim 5.

20. A computer-readable storage medium storing one or more sequences of instructions which, when executed by one or more processors, causes the one or more processors to perform the method recited in claim 6.

21. A computer-readable storage medium storing one or more sequences of instructions which, when executed by one or more processors, causes the one or more processors to perform the method recited in claim 7.

22. A computer-readable storage medium storing one or more sequences of instructions which, when executed by one or more processors, causes the one or more processors to perform the method recited in claim 8.

23. A computer-readable storage medium storing one or more sequences of instructions which, when executed by one or more processors, causes the one or more processors to perform the method recited in claim 9.

24. A computer-readable storage medium storing one or more sequences of instructions which, when executed by one or more processors, causes the one or more processors to perform the method recited in claim 11.

25. A computer-readable storage medium storing one or more sequences of instructions which, when executed by one or more processors, causes the one or more processors to perform the method recited in claim 13.

26. A database apparatus comprising:
a plurality of instances of the database wherein each of the plurality of instances comprises an event monitor, wherein each event monitor has a coordinator and a plurality of slave processes;
a grouping registration facility which manages a plurality of registration requests from registrants wishing to register for grouping notifications; and
a timing module which publishes partial grouping data related to each of the plurality of registrations when a pre-specified time ‘t’ elapses, where ‘f’ is a fraction, 0<f<1, which is a multiplicative factor of the grouping time interval, and where ‘m’ is the minimum supportable periodic refresh time, so that the pre-specified time ‘t’ is t=max (f*grouping time interval, m).
